(19) United States
(12) Patent Application Publication
(10) Pub. No.: US 2026/0077544 A1
(43) Pub. Date: Mar. 19, 2026

(54) PRODUCTION MOLD FOR SPLIT-TYPE GRIT-TEXTURED PACKAGING BOTTLE

(71) Applicant: SHENZHEN PORSHEALTH BIOENGINEERING CO., LTD., SHENZHEN (CN)

(72) Inventors: SHIYI LE, SHENZHEN (CN); XIAOLING OU, SHENZHEN (CN)

(21) Appl. No.: 19/327,166

(22) Filed: Sep. 12, 2025

(30) Foreign Application Priority Data
Sep. 19, 2024 (CN) 202422287861.4

(51) Int. Cl. B29C 45/26; B29C 45/33; B29C 45/40; B29L 22/00

(52) U.S. Cl. CPC B29C 45/2602; B29C 45/332; B29C 45/4005; B29L 2022/00

(57) ABSTRACT

A production mold for a split-type grit-textured packaging bottle includes fixed-mold and movable-mold assemblies. The fixed-mold assembly has top and bottom provided with injection channel and fixed-mold A plate respectively. Fixed-mold insert(s) installed in the fixed-mold A plate communicates with the injection channel, and corresponds to a concave cavity having bottom consistent with product's closed end in shape. Two inclined guide pillars are provided the concave cavity's two sides. The movable-mold assembly's top has a movable-mold B plate provided with a B-plate insert with a concave cavity-facing mold core. The B-plate insert's end relative to the product forms internally as an inverted cone structure. A pushing assembly includes a movable-mold push plate movable on the movable-mold B plate and having a top provided, relative to the concave cavity, with side sliders for correspondingly driving the guide pillars. Sliders'product-facing sides have structures matching grit texture on the product's outer wall.

### CROSS REFERENCE TO RELATED APPLICATIONS

The present disclosure claims the priority to the Chinese patent application with the filing No. 202422287861.4, entitled “PRODUCTION MOLD FOR SPLIT-TYPE GRIT-TEXTURED PACKAGING BOTTLE” and filed on Sep. 19, 2024 with the Chinese Patent Office, the contents of which are incorporated herein by reference in their entirety.

### TECHNICAL FIELD

The present disclosure relates to the field of processing technology of probiotics packaging, and more particularly to a production mold for a split-type grit-textured packaging bottle.

### BACKGROUND ART

Most existing probiotic powder products are packaged in strip bags, which has some shortcomings: when consumers take the product, the strip bag is not easy to tear open, and the gap of the strip bag after tearing is small, making the taking/administration inconvenient. The easy-to-tear edge of the strip bag is serrated, which makes it difficult to tear open, and the gap after tearing is incomplete, making it difficult to pour out the powder. The rounded corner packaging solves the problem of difficulty in tearing, but the gap after tearing is too small, also making the taking/administration inconvenient. After research on the product, it was found that the above problems may be well solved by using bottled products. The probiotic bottle body is divided into upper and lower parts, namely the bottle cap and the lower bottle body structure. The probiotic bottle cap is provided with an upper bottle body below the conventional bottle cap, the upper bottle body and the lower bottle body are engaged with each other, and a sealing structure is provided at the engagement position. The cap and the upper bottle body are integrally formed. When in use, the sealing structure is first removed, and then the cap and the upper bottle body are separated by external force, to take the powder all at once.

The above-mentioned packaging bottle is small in size and has an anti-slip grit texture structure on its outer wall for convenient use. It cannot be demolded smoothly using the existing mold, which may easily cause damage to the anti-slip grit texture structure. The change in external force during mold opening may easily cause the cap to produce relative displacement on the mold core. Since the cap has not been completely cooled, the snap-fitting portion of the cap is stretched/damaged and deformed.

Therefore, how to provide a production mold for a split-type grit-textured packaging bottle is a technical problem to be urgently solved by those skilled in the art.

### SUMMARY

In view of this, the purpose of the present disclosure is to provide a production mold for a split-type grit-textured packaging bottle to solve the demolding problem of the split-type grit-textured packaging bottle.

The technical solution of the present disclosure is a production mold for a split-type grit-textured packaging bottle, including: a fixed mold assembly and a movable mold assembly that cooperate with each other, and a pushing assembly, where the fixed mold assembly has a top provided with an injection channel and a bottom provided with a fixed mold A plate, a fixed mold insert is installed inside the fixed mold A plate, the fixed mold insert communicates with the injection channel, the fixed mold insert corresponds to a concave cavity below, a bottom end of which has a shape consistent with the shape of the closed end of a product; and two inclined guide pillars are provided at two sides of the concave cavity;
the top of the movable mold assembly is provided with a movable mold B plate, and a B plate insert having a mold core facing the concave cavity is mounted on the movable mold B plate, and the interior of the end of the B plate insert relative to the product is formed to be in an inverted cone structure; and
the pushing assembly includes a movable mold push plate, the movable mold push plate is movable on the movable mold B plate, a first side slider and a second side slider configured to correspondingly drive the two inclined guide pillars are provided on the top of the movable mold push plate relative to the concave cavity, and sides of the first side slider and the second side slider facing the product each have a structure that matches the grit texture on the outer wall of the product.

According to the technical solutions of the present disclosure, the difference between the major diameter and the minor diameter of the inverted cone structure is 0.02-0.1 mm.

According to the technical solutions of the present disclosure, the difference between the major diameter and the minor diameter of the inverted cone structure is 0.03-0.04 mm.

According to the technical solutions of the present disclosure, the fixed mold assembly further includes a fixed mold runner plate and a fixed mold panel which are sequentially located on the top of the fixed mold A plate, and a fixed mold guide pillar penetrates through the fixed mold panel, the fixed mold runner plate and the fixed mold A plate; a sprue bushing installed in the injection channel is provided in the fixed mold runner plate, and the top of the fixed mold A plate is provided with a distribution channel communicating with the sprue bushing, and the distribution channel corresponds to a plurality of fixed mold inserts; and the fixed mold panel is connected to a plurality of runner pull pins facing the distribution channel.

According to the technical solution of the present disclosure, the fixed mold panel and the fixed mold runner plate are interconnected with each other by a first pull rod, the fixed mold runner plate and the fixed mold A plate are interconnected with each other by a second pull rod, and the engaged length of the second pull rod is greater than the engaged length of the first pull rod.

According to the technical solutions of the present disclosure, a rubber plug is installed between the fixed mold A plate and the movable mold push plate through a connecting element.

According to the technical solutions of the present disclosure, the movable mold assembly further includes: a movable mold foot and a movable mold panel, the movable mold foot is fixed to the top of the movable mold panel, the movable mold guide pillar is located at the top of the movable mold foot, sequentially penetrates through the movable mold B plate and the movable mold push plate from the bottom up, and extends upward to enter the fixed mold positioning hole of the fixed mold A plate; the lower end of the fixed mold guide pillar can enter the movable mold push plate, the movable mold B plate and the movable mold positioning hole corresponding to the movable mold foot; and a pushing space is formed between the movable mold B plate and the movable mold panel, a support column is provided in the pushing space, the movable mold panel is provided with an ejection hole communicating with the pushing space, and the ejection hole and the support column are staggered.

According to the technical solutions of the present disclosure, the pushing assembly further includes an upper ejector plate and a lower ejector plate which are located in the pushing space, corresponding to the ejection hole, and fixedly connected, the support column penetrates through the upper ejector plate and the lower ejector plate, supports the bottom of the movable mold B plate, and has a height consistent with the height of the movable mold foot; and a return pin is fixed on the lower ejector plate, the bottom of the return pin is provided with a return spring, the return spring is located between the spring hole of the movable mold B plate and the upper ejector plate, and the top of the return pin passes through the movable mold B plate to be fixed to the movable mold push plate.

According to the technical solutions of the present disclosure, the movable mold push plate is provided with a push plate insert, and the push plate insert is located outside the B plate insert and at the bottom of the product.

It can be seen from the above technical solutions that compared with the prior art, the present disclosure has the following beneficial effects.

In the present disclosure, the end of the B plate insert is designed to be in a shape of inverted cone, preventing the product from displacing relative to the movable mold insert during the mold opening. After the fixed mold A plate is separated from the movable mold push plate, an external ejector pin is inserted into the ejection hole, and the ejector plates, return pin, movable mold push plate, and push plate insert are pushed upwards to push the product from the bottom to push it out. In the above process, the problem of damage to the outer wall of a bottle with an anti-slip grit-textured structure is solved, and external force changes during the mold opening do not affect the position of the product on the mold core, further ensuring smooth demolding of the product and meeting the production requirements of split-type grit-textured bottles.

### BRIEF DESCRIPTION OF DRAWINGS

In order to more clearly illustrate the technical solutions in embodiments of the present disclosure or in the prior art, the drawings required for use in the description of the embodiments or the prior art will be briefly introduced below. Obviously, the drawings described below are merely embodiments of the present disclosure. For those ordinarily skilled in the art, other drawings may be obtained based on the provided drawings without paying any creative work.

FIG. 1 is a schematic structural view of a production mold for a split-type grit-textured packaging bottle provided by the present disclosure;

FIG. 2 is a sectional view of the production mold for a split-type grit-textured packaging bottle provided by the present disclosure;

FIG. 3 is an enlarged schematic view of the mold cavity of the production mold for a split-type grit-textured packaging bottle provided by the present disclosure; and

FIG. 4 is an exploded view of the production mold for a split-type grit-textured packaging bottle provided by the present disclosure.

### DETAILED DESCRIPTION OF EMBODIMENTS

The embodiments of the present disclosure will be described in detail below, examples of which are shown in the drawings, where the same or similar reference numerals throughout represent the same or similar elements or elements having the same or similar functions. The embodiments described below with reference to the drawings are exemplary and are intended to explain the present disclosure, and should not be construed as limiting the present disclosure.

Conventionally, in order to solve the problem of difficult demolding of products, interiors of the mode core and the mold cavity are generally made to be in a tapered shape in the demolding direction. However, the above method cannot meet the processing requirements of packaging bottles with grit texture. If the mold core is made to be in a tapered shape, the frictional force of the grit texture of the packaging bottle may increase when being taken out, resulting in easily damaged grit texture. In view of this, the present disclosure provides a solution based on the characteristics of the split-type grit-textured packaging bottles.

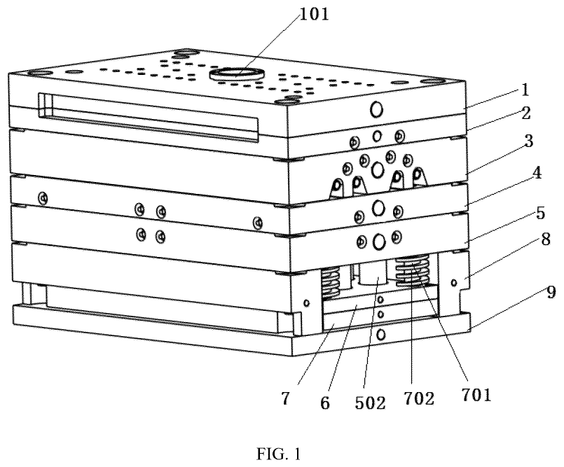

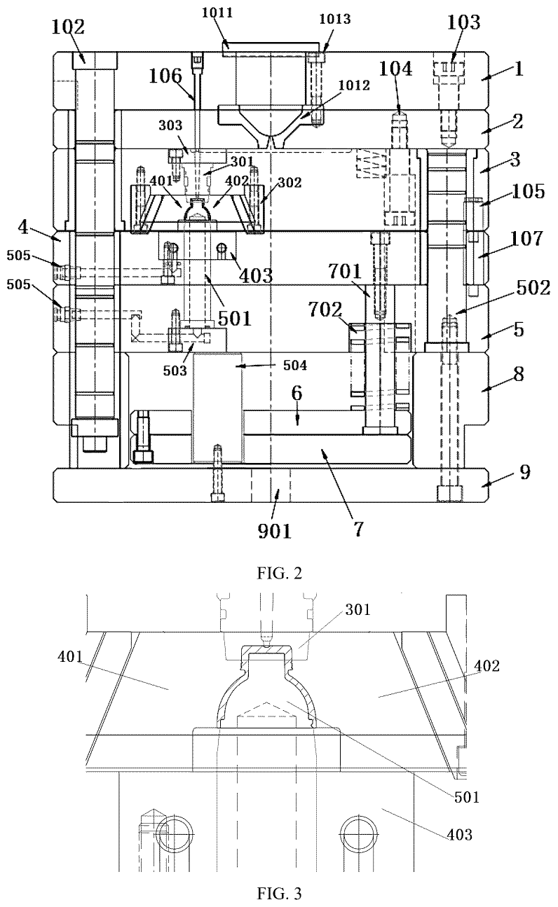

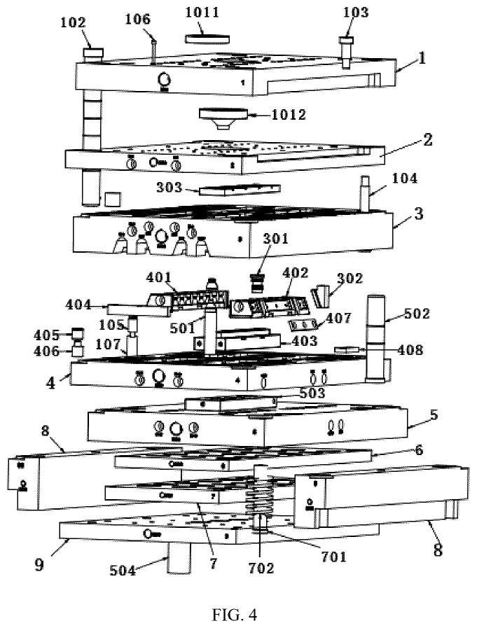

Firstly, the production mold is described by taking the bottle cap part of a grit-textured packaging bottle as an example. Referring to FIG. 1-4, the mold includes: a fixed mold assembly and a movable mold assembly that cooperate with each other, and a pushing assembly, where the top of the fixed mold assembly is provided with an injection channel 101, within which a sprue bushing 1012 is fixed onto the fixed mold assembly via a fastener 1013, a positioning ring 1011 is mounted on the top of the injection channel 101 to facilitate an injection molding machine injecting the molten plastic into the fixed mold, the bottom of the fixed mold assembly is provided with a fixed mold A plate 3, a fixed mold insert 301 is mounted in the fixed mode A plate 3 via a fixed mold pressing plate 303, the fixed mold insert 301 communicates with the injection channel 101, the fixed mold insert 301 corresponds to a concave cavity below, the bottom end of which has a shape consistent with the shape of the closed end of the product, and two inclined guide pillars 302 are provided at two sides of the concave cavity;
the top of the movable mold assembly is provided with a movable mold B plate 5, a B plate insert 501 having a mold core facing the concave cavity is mounted on the movable mold B plate 5, the interior of the end of the B plate insert 501 relative to the product is formed to be in an inverted cone structure, where the B plate insert 501 is fixed onto the movable mold B plate by a movable mold pressing plate 503; and
the pushing assembly includes a movable mold push plate 4, the movable mold push plate 4 is movable on the movable mold B plate 5, a first side slider 401 and a second side slider 402 configured to correspondingly drive the two inclined guide pillars 302 are provided on the top of the movable mold push plate relative to the concave cavity, and sides of the first side slider 401 and the second side slider 402 facing the product each have a structure that matches the grit texture on the outer wall of the product. In the above, the first side slider 401 and the second side slider 402 are fixed and guided by a slide wear strip 404 located on the movable mold push plate 4.

Advantageously, the outer inclined surfaces of the first side slider 401 and the second side slider 402 are each provided with a wear-resistant block 407: the slider directly abuts against the fixed mold A plate through the inclined surface, and a wear-resistant block 407 is added between the two to protect the slider, and avoid slider wear which causes loose mold closing and occurrence of burrs on the product.

Therefore, when the mold is opened, the bottle cap part and the inverted cone structure of the end of the B plate insert 501 remain stable and are not affected by the change in external force when the mold is opened, and finally, they are pushed out by the movable mold push plate 4, ensuring the qualification rate of the product.

In the above embodiment, the difference between the major diameter and minor diameter of the inverted cone structure is 0.02-0.1 mm according to the bending fatigue strength of the material selected for the product. Inelastic materials are not suitable for the inverted cone structure.

In a specific example of the present disclosure, the cap and the bottle body of the packaging bottle may be made of PP material, and the difference between the major diameter and the minor diameter of the inverted cone structure is 0.03-0.04 mm.

In an embodiment of the present disclosure, the fixed mold assembly further includes a fixed mold runner plate 2 and a fixed mold panel 1 which are sequentially located on the top of the fixed mold A plate 3. A fixed mold guide pillar 102 penetrates through the fixed mold panel 1, the fixed mold runner plate 2 and the fixed mold A plate 3; the top of the fixed mold A plate 3 is provided with a distribution channel communicating with the sprue bushing 1012, and the distribution channel corresponds to a plurality of fixed mold inserts 30. That is, the present disclosure can mold multiple products at the same time, each fixed mold insert 301 corresponds to one concave cavity, and each concave cavity correspondingly molds one product, and the fixed mold panel 1 is connected to a plurality of runner pull pins 106 facing the distribution channel.

Advantageously, in order to facilitate the removal of excess molten plastic and reduce the impact of the molten plastic on the product, the fixed mold panel 1 and the fixed mold runner plate 2 are interconnected with each other by a first pull rod 103, the fixed mold runner plate 2 and the fixed mold A plate 3 are interconnected with each other by a second pull rod 104, and the engaged length of the second pull rod 104 is greater than the engaged length of the first pull rod 103.

In the above, the “engaged length” refers to the pull rod moving space left in the fixed mold A plate 3, and the moving space is realized by the stepped hanging hole and the pull rod. For example, when the fixed mold runner plate 2 and the fixed mold A plate 3 are opened (i.e., separated from each other), the second pull rod 104 moves upwards together with the fixed mold runner plate 2. At this time, the upper end surface of the bottom of the second pull rod 104 may abut against the large-hole bottom surface of the stepped hanging hole in the fixed mold A plate 3.

In the description of the present disclosure, it should be understood that the orientation or position relationships indicated by terms “upper”, “lower”, “top”, “bottom”, “inner”, “outer”, etc. are based on the orientation or position relationships shown in the drawings, only for facilitating describing the present disclosure and simplifying the description, rather than indicating or implying that the device or element indicated must have a specific orientation, or be constructed and operated in a specific orientation. Therefore, it should not be understood as a limitation on the present disclosure.

To ensure that excess molten plastic is removed before the mold opening of the product, the present disclosure installs a rubber plug 105 between the fixed mold A plate 3 and the movable mold push plate 4 via a connecting element 107. In the above, the plug plays a function of pulling, during moving of the movable mold, the fixed mold A plate to not be separated from the movable mold push plate, ensuring that the product is separated from the runner first. That is, the fixed mold runner plate and the fixed mold A plate are separated first. The connecting element 107 may be a silver steel wire or a bolt, the silver steel wire or the bolt penetrating through the rubber plug 105. When the fixed mold A plate is separated from the movable mold push plate, the rubber plug may deform. Both the rubber plug and the connecting element are consumable parts.

Based on the above embodiment, the movable mold assembly further includes: a movable mold foot 8 and a movable mold panel 9, where the movable mold foot 8 is fixed to the top of the movable mold panel 9, and the movable mold guide pillar 502 is located at the top of the movable mold foot 8, sequentially penetrates through the movable mold B plate 5 and the movable mold push plate 4 from the bottom up, and extends upwards to enter the fixed mold positioning hole of the fixed mold A plate; the lower end of the fixed mold guide pillar 102 may enter the movable mold positioning hole corresponding to the movable mold push plate 4, the movable mold B plate 5 and the movable mold foot 8; a pushing space is formed between the movable mold B plate 5 and the movable mold panel 9, and a support column 504 is provided in the pushing space, and the movable mode panel 9 is provided with an ejection hole 901 communicating with the pushing space, and the ejection hole 901 is staggered with the support column 504.

The pushing assembly further includes an upper ejector plate 6 and a lower ejector plate 7 which are located in the pushing space, corresponding to the ejection hole 901, and fixedly connected. The support column 504 penetrates through the upper ejector plate 6 and the lower ejector plate 7, supports the bottom of the movable mold B plate 5, and has a height consistent with the height of the movable mold foot 8; a return pin 701 is fixed on the lower ejector plate 7, and a return spring 702 is provided at the bottom of the return pin 701. The return spring 702 is located between the spring hole of the movable mold B plate 5 and the upper ejector plate 6. The top of the return pin 701 passes through the movable mold B plate 5 to be fixed to the movable mold push plate 4.

The movable mold push plate 4 is provided with a push plate insert 403, and the push plate insert 403 is located outside the B plate insert 501 and at the bottom of the product.

In the present disclosure, unless otherwise specified or limited, the terms “install”, “link”, “connect”, “fix” and the like should be understood in a broad sense. For example, it may be fixed connection, detachable connection, or integral connection; It may be mechanical connection or electrical connection; It may be direct connection or indirect connection through an intermediate medium, or may be internal communication between two elements or the interaction between two elements. For those ordinarily skilled in the art, the specific meanings of the above terms in the present disclosure may be understood according to specific circumstances.

During mold opening, under the action of an external force, the fixed mold runner plate 2 and the fixed mold A plate 3 are first opened, to make the product separated from the distribution runner and remove excess molten plastic, the fixed mold face plate 1 is then separated from the fixed mold runner plate 2, the runner pull pins are taken out, and then the movable mold push plate 4 is separated from the fixed mold A plate (a first guide pillar 405 is fixed onto the movable mold push plate 4, and a second guide pillar 406 cooperating with the first guide pillar is fixed onto the fixed mold A plate, plays a concentric guiding role during mold opening and mold closing of the movable mold push plate and the fixed mold A plate, particularly during the mold closing), and synchronously, the inclined guide pillars in the fixed mold A plate directly move the sliders by their inclination, to make the product separated from the mold cavity. The product is then pushed out by the pushing assembly, the ejector pin retracts, the movable mold push plate is pulled back through the return spring, and then the movable mold moves to achieve mold closing, and this cycle repeats.

It should be indicated that a balancing block 408 may be provided between the movable mold push plate and the fixed mold A plate. The balancing block may be fixed on the movable mold push plate to effectively protect the movable mold push plate and the fixed mold A plate from unbalanced mold pressing during mold closing, effectively protect parts such as the sliders of the mold, and fixed and movable mold inserts.

The basic principles of the mold for the bottle body and the mold for the bottle cap are the same, except that the mold cavity shape and insert structure need to be modified accordingly according to the structure of the bottle body.

The production mold of the present disclosure may be used not only in the production of probiotic packaging bottles, but also in the production of packaging bottles similar to the packaging bottles, thereby solving the problem of difficult demolding.

In the description of this specification, the description with reference to terms “one embodiment”, “some embodiment”, “example”, “specific example”, or “some examples” means that the specific features, structures, materials, or characteristics described in conjunction with the embodiment or example are included in at least one embodiment or example of the present disclosure. In this specification, the schematic expressions of the above terms do not necessarily refer to the same embodiment or example. Moreover, the specific features, structures, materials, or characteristics described may be combined in any one or more embodiments or examples in a suitable manner. In addition, those skilled in the art may couple and combine different embodiments or examples described in the specification.

Although the embodiments of the present disclosure have been shown and described above, it may be understood that the above embodiments are exemplary and are not to be construed as limiting the present disclosure. Those ordinarily skilled in the art may make changes, modifications, substitutions, and variations to the above embodiments within the scope of the present disclosure.

1. A production mold for a split-type grit-textured packaging bottle, comprising a fixed mold assembly and a movable mold assembly which are configured to cooperate with each other, and a pushing assembly,
wherein the fixed mold assembly has a top provided with an injection channel, and a bottom provided with a fixed mold A plate, a fixed mold insert is installed in the fixed mold A plate, and the fixed mold insert communicates with the injection channel, the fixed mold insert corresponds to a concave cavity below, a bottom end of which has a shape consistent with a shape of a closed end of a product, and two inclined guide pillars are provided at two sides of the concave cavity;
a top of the movable mold assembly is provided with a movable mold B plate, a B plate insert having a mold core facing the concave cavity is installed on the movable mold B plate, and an interior of an end of the B plate insert relative to the product is formed to be in an inverted cone structure; and
the pushing assembly comprises a movable mold push plate, the movable mold push plate is movable on the movable mold B plate, a first side slider and a second side slider configured to correspondingly drive the two inclined guide pillars are provided at a top of the movable mold push plate relative to the concave cavity, and sides of the first side slider and the second side slider facing the product each have a structure matching a grit texture on an outer wall of the product.

2. The production mold for a split-type grit-textured packaging bottle according to claim 1, wherein a difference between a major diameter and a minor diameter of the inverted cone structure is 0.02-0.1 mm.

3. The production mold for a split-type grit-textured packaging bottle according to claim 2, wherein the difference between the major diameter and the minor diameter of the inverted cone structure is 0.03-0.04 mm.

4. The production mold for a split-type grit-textured packaging bottle according to claim 1, wherein the fixed mold assembly further comprises a fixed mold runner plate and a fixed mold panel sequentially located on a top of the fixed mold A plate, a fixed mold guide pillar penetrates through the fixed mold panel, the fixed mold runner plate and the fixed mold A plate; a sprue bushing installed in the injection channel is provided in the fixed mold runner plate, the top of the fixed mold A plate is provided with a distribution channel communicating with the sprue bushing, and the distribution channel corresponds to a plurality of fixed mold inserts; and the fixed mold panel is connected to a plurality of runner pull pins facing the distribution channel.

5. The production mold for a split-type grit-textured packaging bottle according to claim 4, wherein the fixed mold panel and the fixed mold runner plate are interconnected with each other by a first pull rod, the fixed mold runner plate and the fixed mold A plate are interconnected with each other by a second pull rod, and an engaged length of the second pull rod is greater than an engaged length of the first pull rod.

6. The production mold for a split-type grit-textured packaging bottle according to claim 4, wherein a rubber plug is installed between the fixed mold A plate and the movable mold push plate via a connecting element.

7. The production mold for a split-type grit-textured packaging bottle according to claim 4, wherein the movable mold assembly further comprises: a movable mold foot and a movable mold panel, the movable mold foot is fixed to a top of the movable mold panel, and a movable mold guide pillar is located at a top of the movable mold foot, sequentially penetrates through the movable mold B plate and the movable mold push plate from bottom up, and extends upwards to enter a fixed mold positioning hole of the fixed mold A plate; a lower end of the fixed mold guide pillar can enter a movable mold positioning hole corresponding to the movable mold push plate, the movable mold B plate and the movable mold foot; a pushing space is formed between the movable mold B plate and the movable mold panel, and a support column is provided in the pushing space, the movable mold panel is provided with an ejection hole communicating with the pushing space, and the ejection hole and the support column are staggered.

8. The production mold for a split-type grit-textured packaging bottle according to claim 7, wherein the pushing assembly further comprises an upper ejector plate and a lower ejector plate which are located in the pushing space, corresponding to the ejection hole, and fixedly connected, the support column penetrates through the upper ejector plate and the lower ejector plate, supports a bottom of the movable mold B plate, and has a height consistent with a height of the movable mold foot; a return pin is fixed on the lower ejector plate, and a return spring is provided at a bottom of the return pin, and the return spring is located between a spring hole of the movable mold B plate and the upper ejector plate, and a top of the return pin passes through the movable mold B plate to be fixed to the movable mold push plate.

9. The production mold for a split-type grit-textured packaging bottle according to claim 8, wherein the movable mold push plate is provided with a push plate insert, and the push plate insert is located outside the B plate insert and at a bottom of the product.
